(19) United States
(12) Patent Application Publication
(10) Pub. No.: US 2016/0125777 A1
(43) Pub. Date: May 5, 2016

(54) Image Sticking Prevention Using an Information Handling System Webcam

(71) Applicant: DELL PRODUCTS L.P., Round Rock, TX (US)

(72) Inventors: Lawrence E. Knepper, Leander, TX (US); Mark W. Welker, West Lake Hills, TX (US); Jorge A. Abullarade, Austin, TX (US)

(73) Assignee: DELL PRODUCTS L.P., Round Rock, TX (US)

(21) Appl. No.: 14/528,373

(22) Filed: Oct. 30, 2014

(51) Int. Cl. G09G 3/00; G06F 3/01; G06T 5/00

(52) U.S. Cl. CPC G09G 3/007; G06T 5/002; G06F 3/013; G09G 2320/0247

(57) ABSTRACT

A system, method, and computer-readable medium for reducing image sticking by jittering an image enough so that sharp borders in the image are not always displayed on the same set of pixel elements. This jittering can also cause sharp borders of an image to be sufficiently blurred so as to not leave a visible line artifact on the screen after the user changes to a different image. More specifically, the system uses a webcam in conjunction with an eye tracking function to monitor a user and only allow the image to be jittered during the short intervals over which the user is not actually looking at the screen. This monitoring allows for the displacement of the jitter function to be greater and more effective, without being visible to the user, so as to avoid an annoying user experience.

### BACKGROUND OF THE INVENTION

1. Field of the Invention

The present invention relates to information handling systems. More specifically, embodiments of the invention relate to image sticking prevention using an information handling system webcam.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to present information generated by information handling systems via display devices. There are certain issues relating to information handing system display devices. For example, with certain information handling system display devices, such as active matrix organic light emitting diode (AMOLED) display devices, can have an issue with image burn-in (sometimes referred to as “image sticking”). Image burn-in can be caused by differential aging of individual organic light emitting diode (OLED) elements over time with usage.

Image sticking has been an issue since cathode ray tube (CRT) displays. Image sticking also is an issue with flat panel displays such as plasma displays. Known methods to reduce or prevent image sticking include use of moving screen savers, reducing contrast, and even pixel shifting. All of these methods involve changes to the image (or in the case of a screen saver the user no longer sees the image) that to one extent or another result in a viewing experience that is compromised.

Accordingly, it would be desirable to provide a means for preventing image sticking in such a manner as to not be perceptible to a user.

### SUMMARY OF THE INVENTION

A system, method, and computer-readable medium are disclosed for reducing image sticking by jittering an image enough so that sharp borders in the image are not always displayed on the same set of pixel elements (e.g., OLEDs). This jittering can also cause sharp borders of an image to be sufficiently blurred so as to not leave a visible line artifact on the screen after the user changes to a different image. More specifically, the system uses a webcam in conjunction with an eye tracking function to monitor a user and only allow the image to be jittered during the short intervals over which the user is not actually looking at the screen. This monitoring allows for the displacement of the jitter function to be greater and more effective, without being visible to the user, so as to avoid an annoying user experience.

More specifically in certain embodiments, the jitter operation interacts with an eye-tracking function which in turn interacts with a webcam coupled to the information handing system. The eye-tracking function determines when a user is looking at a screen of a display device and when the user is not looking at the screen. When the user is not looking at the screen, the entire image is displaced in a number of directions (i.e. a different direction each time, at random), for a number of pixel distances sufficient to mitigate image sticking When the eye tracking function determines that the user's gaze is again directed at the screen, the system pauses jittering so that the user perceives a stable image.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows s a general illustration of components of an information handling system as implemented in the system and method of the present invention.

FIG. 2 shows a flow diagram of the operation of the various components of an image sticking prevention system.

FIG. 3 shows a flow chart of the operation of an image sticking prevention system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

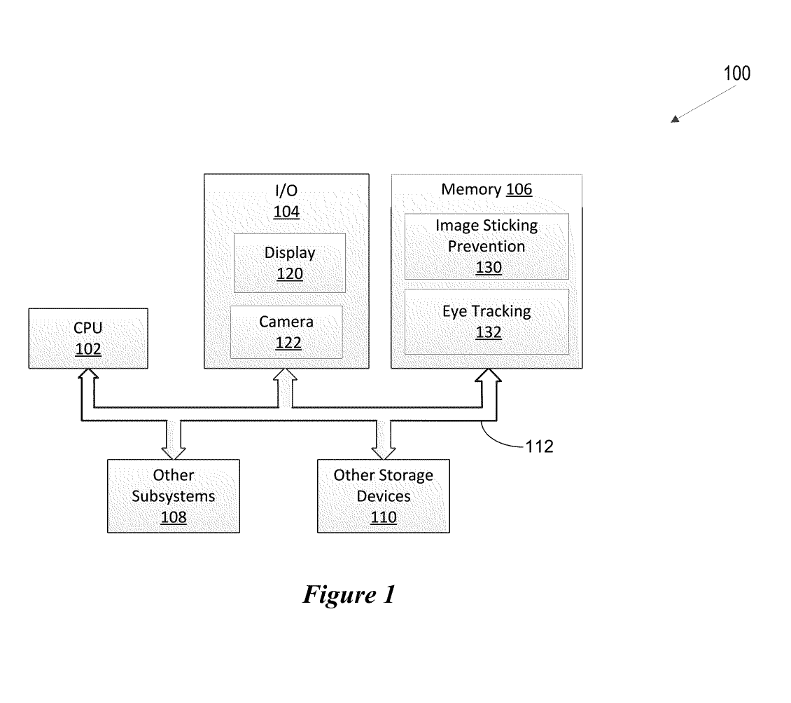

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display device 120, a camera 122 (such as an integrated video camera (also sometimes referred to as a webcam)), a keyboard, a mouse, and associated controllers, memory 106, and various other subsystems 108. The information handling system 100 likewise includes other storage devices 110. The components of the information handling system are interconnected via one or more buses 112. In certain embodiments, the display device 120 comprises an AMOLED type display device screen. The information handling system also includes an image sticking prevention module 130 as well as an eye tracking system 132 stored within the memory 106 and containing instruction for execution by the processor 102.

The image sticking prevention system 130 reduces image sticking on the display device 120 by jittering an image enough so that sharp borders in the image are not always displayed on the same set of pixel elements (e.g., a set of OLEDs). This jittering can also cause sharp borders of an image to be sufficiently blurred so as to not leave a visible line artifact on the screen after the user changes to a different image. More specifically, the system uses the webcam 122 in conjunction with the eye tracking system 132 to monitor a user and only allow the image to be jittered during the short intervals over which the user is not actually looking at the screen. This monitoring allows for the displacement of the jitter function to be greater and more effective, without being visible to the user, so as to avoid an annoying user experience.

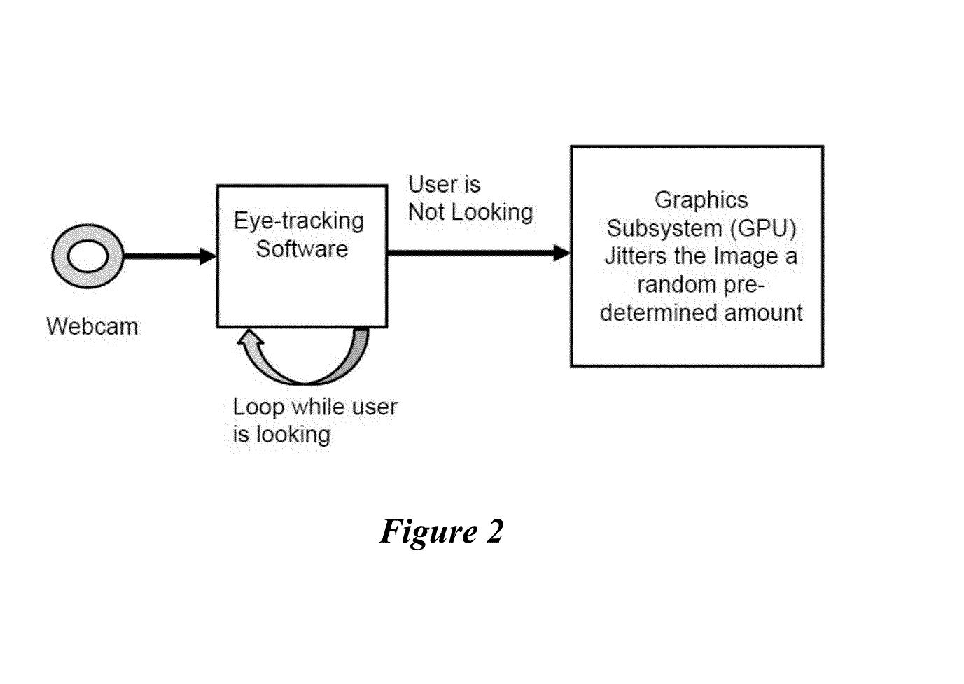

FIG. 2 shows a flow diagram of the operation of the various components of an image sticking prevention system 200. More specifically, the image sticking prevention system 200 includes the camera (e.g., a webcam) 122, the eye tracking system 132 and the image sticking prevention module 130.

More specifically in operation, the image sticking prevention module 130 interacts with the eye-tracking system 132 which in turn interacts with a webcam 122 coupled to the information handing system. The eye-tracking system performs an eye tracking operation to determine when a user is looking at a screen of a display device and when the user is not looking at the screen. When the user is not looking at the screen, the image sticking prevention module jitters the image (i.e., displaces the entire image) in a number of directions (i.e. a different direction each time, at random), for a number of pixel distances sufficient to mitigate image sticking When the eye tracking system 132 determines that the user's gaze is again directed at the screen, the image sticking prevention module 130 pauses jittering so that the user perceives a stable image. In certain embodiments, the image sticking prevention module 130 interacts with a graphics subsystem of the information handling system 100 (such as a graphics processing unit (GPU)) to produce the image jitter.

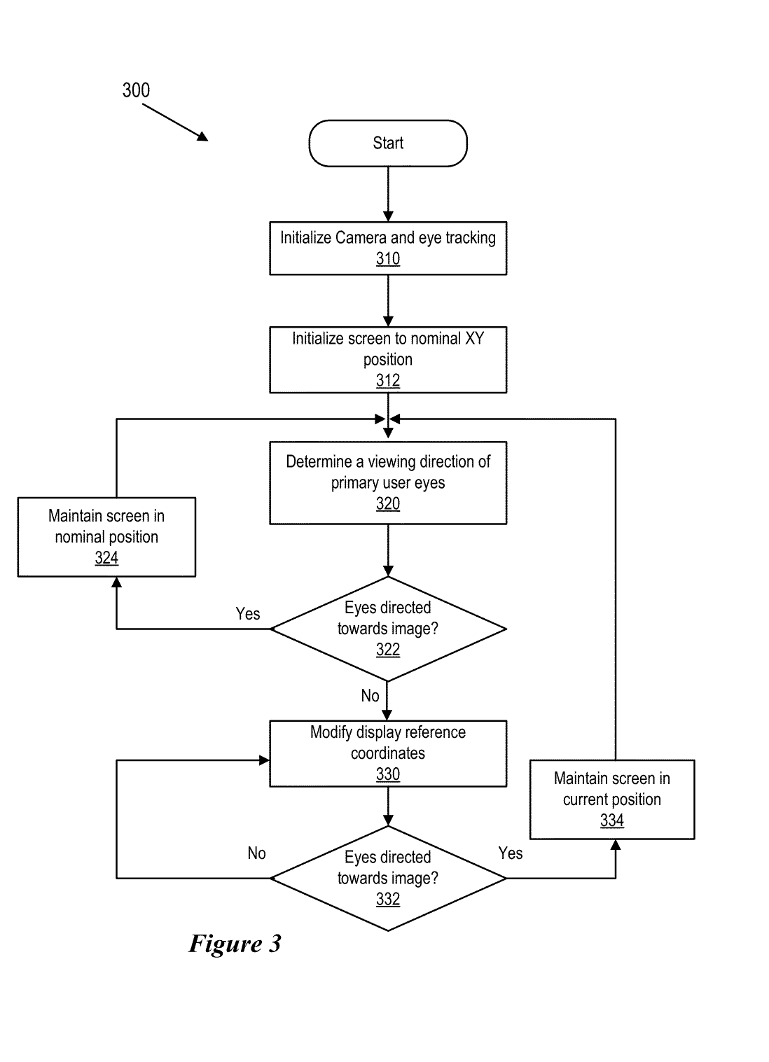

FIG. 3 shows a flow chart of the operation 300 of an image sticking prevention system 130. More specifically, the image sticking prevention system 130 begins operation by initializing the camera 122 and the eye tracking system 132 at step 310. Next at step 312, the image sticking prevention system 130 initializes the screen of the display device 120 to a nominal position. In certain embodiments, the nominal position is identified by predetermined XY coordinates corresponding to a particular pixel position.

Next, the image sticking prevention system 200 begins execution of a first loop. During this first loop, the image sticking prevention system 130 determines a viewing direction of the eyes of a primary user at step 320. Next, at step 322, the image sticking prevention system 130 determines whether the user is looking at the image presented on the display screen based upon the viewing direction of the eyes. If the eyes are looking at the image presented on the display device then at step 324, the image sticking prevention system maintains the image presented on the screen in a normal position where the normal position is based upon the initialized nominal position.

If the eyes are not looking at the image presented on the display device then at step 330 the image sticking prevention system 130 modifies the display reference coordinates by a certain number of pixels, this modification causes the image to jitter. In certain embodiments, the modification is in an X direction, a Y direction, or a combination of an X direction and a Y direction. Also, in certain embodiments, the modification is a random number of pixels in an X direction, a Y direction, or a combination of an X direction and a Y direction, where the random numbers are randomized each time step 330 executes. Also, in certain embodiments, each random number is bounded by an upper limit (e.g., by a defined percentage (e.g., 2%) of the overall X and Y pixel spans of the display device pixels in each of the X and Y directions) to prevent the jitter from becoming too large. Also in certain embodiments, the bound is related to the resolution of the display device such that for a higher resolution display device the bound is larger when compared to a lower resolution display device where the bound is smaller.

Next, at step 332, after a predetermined amount of time (e.g., after a certain number of seconds) the image sticking prevention system 130 determines whether the user is looking at the image presented on the display screen based upon the viewing direction of the eyes. If the eyes are not looking at the image presented on the display device then the image sticking prevention system 130 loops back to step 330. If the eyes are looking at the image presented on the display device then at step 334, the image sticking prevention system 130 maintains the image presented on the screen in a current position. In certain embodiments, the current position corresponds to a previously modified position and returns to the first loop.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1. A computer-implementable method for reducing image sticking within a display device, comprising:
monitoring a user to determine when the user is viewing a screen of the display device;
jittering an image presented on the screen of the display device when the user is not viewing the screen of the display device;
stabilizing the image presented on the screen of the display device when the user is viewing the screen of the display device.

2. The method of claim 1, wherein
the monitoring is performed by a camera integrated within the display device.

3. The method of claim 2, wherein:
the monitoring is performed by an eye tracking module interacting with the camera.

4. The method of claim 1, wherein:
the jittering is performed by modifying display reference coordinates by a certain number of pixels of the display device.

5. The method of claim 4, wherein:
the certain number of pixels comprise a random number of pixels in an X direction, a Y direction, or a combination of an X direction and a Y direction, where the random number of pixels are randomized each time the jittering is performed.

6. The method of claim 5, wherein:
each random number of pixels is bounded by an upper limit to prevent the jitter from becoming too large.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
monitoring a user to determine when the user is viewing a screen of the display device;
jittering an image presented on the screen of the display device when the user is not viewing the screen of the display device;
stabilizing the image presented on the screen of the display device when the user is viewing the screen of the display device.

8. The system of claim 7, wherein:
the monitoring is performed by a camera integrated within the display device.

9. The system of claim 7, wherein:
the monitoring is performed by an eye tracking module interacting with the camera.

10. The system of claim 7, wherein:
the jittering is performed by modifying display reference coordinates by a certain number of pixels of the display device.

11. The system of claim 10, wherein:
the certain number of pixels comprise a random number of pixels in an X direction, a Y direction, or a combination of an X direction and a Y direction, where the random number of pixels are randomized each time the jittering is performed.

12. The system of claim 11, wherein:
each random number of pixels is bounded by an upper limit to prevent the jitter from becoming too large.

13. A non-transitory, computer-readable storage medium embodying computer program code, the computer program code comprising computer executable instructions configured for:
monitoring a user to determine when the user is viewing a screen of the display device;
jittering an image presented on the screen of the display device when the user is not viewing the screen of the display device;
stabilizing the image presented on the screen of the display device when the user is viewing the screen of the display device.

14. The non-transitory, computer-readable storage medium of claim 13, wherein:
the monitoring is performed by a camera integrated within the display device.

15. The non-transitory, computer-readable storage medium of claim 13, wherein:
the monitoring is performed by an eye tracking module interacting with the camera.

16. The non-transitory, computer-readable storage medium of claim 13, wherein:
the jittering is performed by modifying display reference coordinates by a certain number of pixels of the display device.

17. The non-transitory, computer-readable storage medium of claim 16, wherein
the certain number of pixels comprise a random number of pixels in an X direction, a Y direction, or a combination of an X direction and a Y direction, where the random number of pixels are randomized each time the jittering is performed.

18. The non-transitory, computer-readable storage medium of claim 17, wherein:
each random number of pixels is bounded by an upper limit to prevent the jitter from becoming too large.
